(19) United States
(12) Patent Application Publication
(10) Pub. No.: US 2021/0125761 A1
(43) Pub. Date: Apr. 29, 2021

(54) SUPERCONDUCTING MAGNET AND METHOD OF MANUFACTURING SUPERCONDUCTING MAGNET

(71) Applicant: Mitsubishi Electric Corporation, Chiyoda-ku, Tokyo (JP)

(72) Inventors: Yusuke MORITA, Tokyo (JP); Masayoshi OYA, Tokyo (JP)

(73) Assignee: Mitsubishi Electric Corporation, Chiyoda-ku, Tokyo (JP)

(21) Appl. No.: 17/043,831

(22) PCT Filed: May 31, 2018
(86) PCT No.: PCT/JP2018/021014

§ 371 Date: Sep. 30, 2020

(51) Int. Cl. H01F 6/06; H01F 41/04

(52) U.S. Cl. CPC H01F 6/06; H01F 41/048

(57) ABSTRACT

A superconducting magnet includes a wound superconducting wire material. The superconducting wire material includes a configuration part in which, based on a difference in magnitude of a magnetic flux density which varies depending on at which the superconducting wire material is wound, a sectional area of a part having a relatively low magnetic flux density is smaller than a sectional area of a part having a relatively high magnetic flux density.

### TECHNICAL FIELD

The present invention relates to a superconducting magnet in which a superconducting wire material is wound into a coil, to thereby generate a magnetic field.

### BACKGROUND ART

In a superconducting magnet, in order to uniformize a central magnetic field in an axial direction of the superconducting magnet, a plurality of coils formed by winding a superconducting wire material are required to be arranged in a dispersed manner in the axial direction and radial direction of the superconducting magnet. Coils in a superconducting magnet of the related art are formed with the use of a tape-like superconducting wire material (see Patent Literature 1, for example). In this case, the width of the superconducting wire material is constant throughout the entire superconducting magnet in a direction in which the superconducting wire material runs.

### CITATION LIST

### Patent Literature

[PTL 1] JP 04-188706 A

### SUMMARY OF INVENTION

### Technical Problem

When the coils are arranged in the axial direction and radial direction of the superconducting magnet, however, the load factor of the superconducting wire material greatly varies depending on the positions of the coils, due to magnetic flux density. The load factor is expressed by a ratio of an operating current to a critical current. In the superconducting magnet described in Patent Literature 1, the width of the superconducting wire material is constant throughout the entire superconducting magnet. The wire material width is consequently excessive in a portion of the superconducting wire material that has a low load factor, which is a wasteful use of the superconducting wire material. It is therefore desired to keep the cost of manufacturing a superconducting magnet low by eliminating such wasting of a superconducting wire material.

The present invention has been made to solve the problem described above, and an object of the present invention is therefore to provide a superconducting magnet that can be kept low in manufacturing cost.

### Solution to Problem

According to one embodiment of the present invention, there is provided a superconducting magnet including a wound superconducting wire material, wherein the superconducting wire material includes a configuration part in which, based on a difference in a magnitude of a magnetic flux density which varies depending on a position at which the superconducting wire material is wound, a sectional area of a part having the relatively low magnetic flux density is formed to be smaller than a sectional area of a part having the relatively high magnetic flux density.

### Advantageous Effects of Invention

According to the superconducting magnet of the present invention, the wasting of the superconducting wire material is reduced and the superconducting wire material can be used effectively by varying the width of the superconducting wire material depending on the load factor. The manufacturing cost of the superconducting magnet can thus be kept low.

### BRIEF DESCRIPTION OF DRAWINGS

FIG. 1 is a perspective view as well as partial sectional view for illustrating a superconducting magnet according to a first embodiment of the present invention.

FIG. 2 is a sectional view for illustrating a superconducting wire material of FIG. 1.

FIG. 3 is a sectional view in a thickness direction for illustrating a state in which two superconducting wire materials are connected.

FIG. 4 is a sectional view for illustrating a superconducting wire material of a superconducting magnet according to a second embodiment of the present invention.

FIG. 5 is a schematic diagram for illustrating a state in which coils are connected.

FIG. 6 is a sectional view for illustrating a superconducting wire material of a superconducting magnet according to a third embodiment of the present invention.

### DESCRIPTION OF EMBODIMENTS

Now, embodiments of the present invention are described with reference to the drawings. In the drawings, like or corresponding parts are denoted by like symbols, and redundant description is omitted.

### First Embodiment

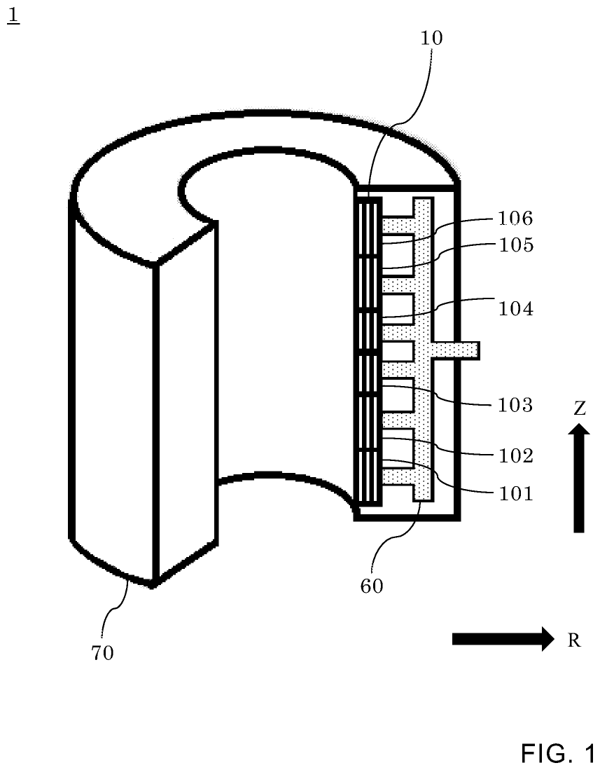

FIG. 1 is a perspective view as well as partial sectional view for illustrating a superconducting magnet according to a first embodiment of the present invention. The sectional view is a view of a cross section including a radial direction of a superconducting magnet 1, which is indicated by an arrow R of FIG. 1, and an axial direction of the superconducting magnet 1, which is indicated by an arrow Z of FIG. 1. In the following description, the radial direction of the superconducting magnet 1 indicated by the arrow R is expressed as “radial direction R”, and the axial direction of the superconducting magnet 1 indicated by the arrow Z is expressed as “axial direction Z”.

The superconducting magnet 1 according to the first embodiment includes a series of wound pieces of a superconducting wire material 10. The superconducting magnet 1 includes six coils, namely, a coil 101 to a coil 106. The six coils 101 to 106 are stacked along the axial direction Z.

Each of the six coils 101 to 106 is a pancake coil and is formed by winding a piece of the superconducting wire material 10 into a circular shape. In this example, the superconducting wire material 10 is wound three turns in each of the coils 101 to 106. The pieces of the superconducting wire material 10 of the six coils 101 to 106 are connected to one another to form a series. For example, one end portion of the piece of the superconducting wire material 10 of the coil 101 is connected to one end portion of the piece of the superconducting wire material 10 of the coil 102.

Types of superconducting wire materials are now described. As the superconducting wire materials, there are low-temperature superconducting wire materials and high-temperature superconducting wire materials. High-temperature superconducting wire materials include rare-earth barium copper oxide (REBCO) wire materials (wire materials made from copper oxide superconductors containing rare earth elements; hereinafter referred to as “thin-film wire materials”) and bismuth-based wire materials. The thin-film wire materials and bismuth-based wire materials are both tape-like wire materials. The thin-film wire materials have a substrate on which a superconducting layer is to be formed by evaporation or other methods. The bismuth-based wire materials have no substrates. In this example, a thin-film wire material is used.

The superconducting wire material 10 has a rectangular shape having a width and a thickness in a cross section perpendicular to a longitudinal direction of the superconducting wire material 10. The superconducting wire material 10 is wound so that its thickness direction is the radial direction R. The thickness of the superconducting wire material 10 is, for example, from several ten μm to several hundred μm.

A conductive cooling plate 60 is provided outside the superconducting wire material 10 in the radial direction R. The conductive cooling plate 60 cools the superconducting wire material 10. The superconducting wire material 10 and the conductive cooling plate 60 are housed in a bracket 70 having a cylindrical shape.

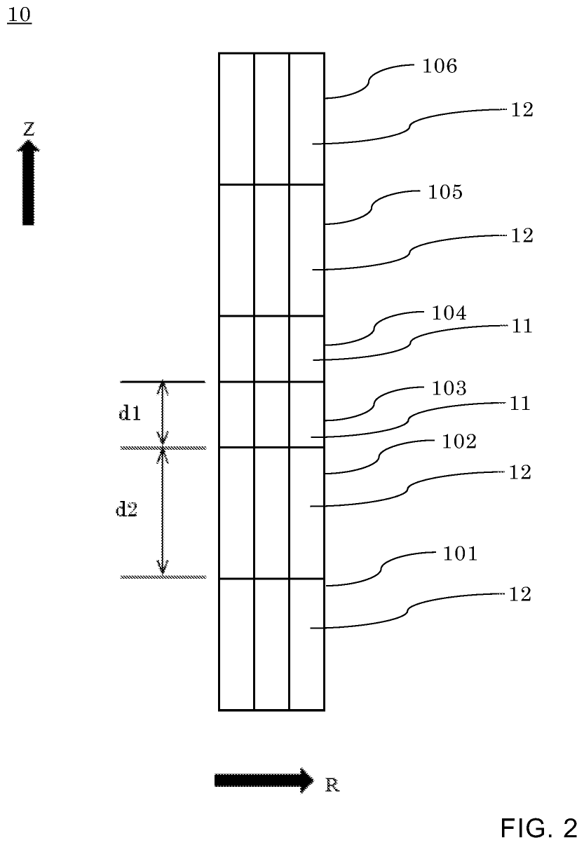

FIG. 2 is a sectional view for illustrating the superconducting wire material of FIG. 1. The illustration of the conductive cooling plate 60 is omitted in FIG. 2. The width of the superconducting wire material 10 is a length in the axial direction Z. Four coils 101, 102, 105, and 106 of the six coils 101 to 106 are each formed from a second wire material portion 12 having a second width d2. Two coils 103 and 104 are each formed from a first wire material portion 11 having a first width d1. The two first wire material portions 11 are placed closer to the center in the axial direction Z than the second wire material portions 12 are, that is, so as to be sandwiched between the second wire material portions 12. In the superconducting wire material 10, the first wire material portions 11 having the same width are connected to each other, the second wire material portions 12 having the same width are connected to each other, and the first wire material portion 11 and the second wire material portion 12, which differ from each other in width, are connected to each other, to thereby form a series of wire material portions.

The first width d1 is less than the second width d2. The thickness of the superconducting wire material 10 in the first wire material portions 11 is the same as the thickness of the superconducting wire material 10 in the second wire material portions 12. A first sectional area S1 of each of the first wire material portions 11 is accordingly smaller than a second sectional area S2 of each of the second wire material portions 12.

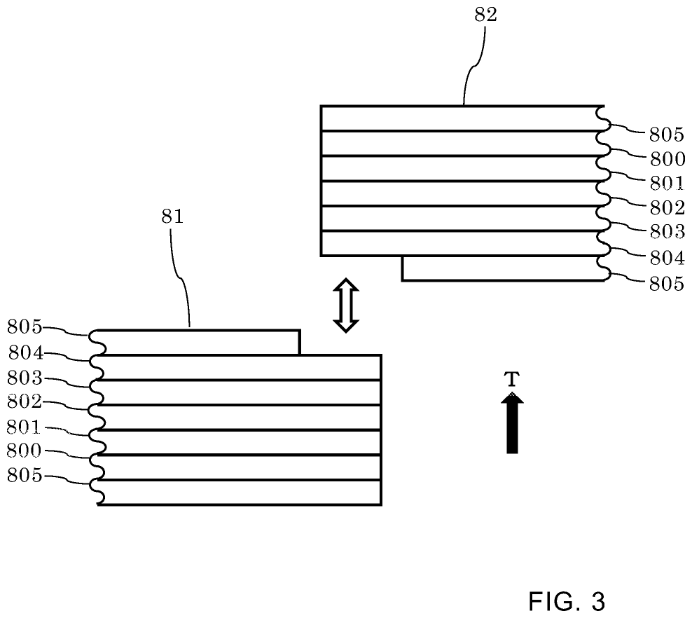

FIG. 3 is a sectional view in a thickness direction for illustrating a state in which two superconducting wire materials are connected. In this example, two superconducting wire materials 81 and 82 each include an insulating tape 805, a substrate 800, an intermediate layer 801, a superconducting layer 802 as a superconductor, a protective layer 803, a stabilizing layer 804, and the insulating tape 805, which are stacked in a thickness direction indicated by an arrow T of FIG. 3. The insulating tape 805 is wound around the components from the substrate 800 to the stabilizing layer 804. The stabilizing layer 804 is formed of, for example, copper. The superconducting wire material 82 is upside down.

To connect the two superconducting wire materials 81 and 82, the insulating tape 805 of each of the superconducting wire materials 81 and 82 is partially peeled first to expose the stabilizing layer 804. Next, the stabilizing layer 804 of the superconducting wire material 81 and the stabilizing layer 804 of the superconducting wire material 82 are opposed to each other to be connected by, for example, solder. Next, the connected portion is covered with, for example, an insulating tape in order to protect the connected portion. Structures other than the one described above may be used as long as the superconducting wire materials are tape-like.

On the opposite side from the side on which the superconducting wire material 82 is connected to the superconducting wire material 81, a superconducting wire material is connected to the superconducting wire material 82 from the lower side of FIG. 3. The front and rear of the superconducting wire material 82 are accordingly switched each time the superconducting wire material 82 is connected. Coils adjacent to each other have turn directions inverse to each other in order to have the same magnetic flux direction.

The action of the superconducting magnet 1 is described next. A superconducting wire material forming a coil that is low in magnetic flux density has a large critical current. A constant current flows in coils connected in series. The load factor of a superconducting wire material forming a coil that is low in magnetic flux density is accordingly lower than the load factor of a superconducting wire material forming a coil that is high in magnetic flux density. That is, there is a relationship in which the load factor rises when the magnetic flux density increases and the load factor drops when the magnetic flux density decreases.

When a plurality of coils are stacked in an axial direction of a superconducting magnet, the magnetic flux density in coils close to the center in the axial direction is lower than the magnetic flux density in coils close to the ends in the axial direction. The load factor of a superconducting wire material forming the coils close to the center in the axial direction of the superconducting magnet is accordingly lower than the load factor of a superconducting wire material forming the coils close to the ends. A current can flow in a superconducting wire material low in load factor with a superconductive state maintained even when the superconducting wire material is small in sectional area.

In the example illustrated in FIG. 2, the six coils 101 to 106 are stacked in the axial direction Z of the superconducting magnet 1. The two first wire material portions 11 are placed closer to the center in the axial direction Z of the superconducting magnet than the four second wire material portions 12 are. That is, a central portion in the axial direction Z, in which the first wire material portions 11 are wound, is lower in magnetic flux density than end portions in the axial direction Z, in which the second wire material portions are wound. The load factor of the first wire material portions 11 is therefore lower than the load factor of the second wire material portions 12.

A first sectional area S1 in the first wire material portions 11 is accordingly set smaller than a second sectional area S2 in the second wire material portions 12 by setting a narrow width to the first width d1 in the first wire material portions 11. The superconducting wire material can thus be used effectively with the used amount and weight of the superconducting wire material being reduced. This keeps the manufacturing cost of the superconducting magnet low. The manufactured superconducting magnet is also downsized in the axial direction.

The first sectional area S1 of each of the first wire material portions 11 is the smallest of sectional areas of the superconducting wire material 10, and the second sectional area S2 of each of the second wire material portions 12 is the largest of the sectional areas of the superconducting wire material 10. The first wire material portions 11 having the smallest sectional area are therefore placed closer to the inner side of the axial direction of the superconducting magnet 1 than the second wire material portions 12 having the largest sectional area are. This keeps the manufacturing cost of the superconducting magnet low.

In the case described in the first embodiment, the superconducting wire material 10 includes two types of wire material portions having different sectional areas. However, the same effects can be obtained also in a case in which the superconducting wire material 10 includes three or more types of wire material portions having different sectional areas.

A component of the magnetic flux density that relates to the size of the sectional area is now described for each type of superconducting wire material. In the case of a low-temperature superconducting wire material, the critical current of the superconducting wire material is large, and the sectional area of the superconducting wire material can therefore be set small when the absolute value of the magnetic flux density is small.

In the case of a high-temperature superconducting wire material, on the other hand, the critical current of the superconducting wire material is large, and the sectional area of the superconducting wire material can therefore be set small when a component of the magnetic flux density in the radial direction of the superconducting magnet in which the superconducting wire material is wound is small. This is because magnetic field characteristics have anisotropy in the case of a high-temperature superconducting wire material.

In the first embodiment, the superconducting wire material 10 is a high-temperature superconducting wire material. The sectional area of the superconducting wire material 10 can therefore be changed based on a radial direction component of the magnetic flux density in the radial direction of the superconducting magnet 1. The first wire material portions 11 are wound on the inner side of the axial direction Z, on which the radial direction component of the magnetic flux density in the radial direction of the superconducting magnet 1 is relatively small. The second wire material portions 12 are wound on the outer side of the axial direction Z, on which the radial direction component of the magnetic flux density in the radial direction of the superconducting magnet 1 is relatively large. The sectional area of the superconducting wire material 10, that is, the width of the superconducting wire material 10, is accordingly set small in the first wire material portions 11.

According to the superconducting magnet of the first embodiment, the sectional area of the superconducting wire material is set smaller in a portion relatively low in magnetic flux density, which varies depending on where the superconducting wire material is wound, than in a portion relatively high in magnetic flux density. More specifically, in the portion relatively low in magnetic flux density, the load factor is low, and a piece of superconducting wire material small in the sectional area taken along a plane perpendicular to the longitudinal direction of the superconducting wire material is accordingly used. Effective utilization of the superconducting wire material is consequently accomplished with a reduction of the wasteful use of the superconducting wire material, which helps to keep the manufacturing cost of the superconducting magnet low.

According to the superconducting magnet of the first embodiment, the width of the superconducting wire material is varied. The width of the superconducting wire material is easy to change compared to the thickness of the superconducting wire material. As a result, the manufacturing cost of the superconducting magnet can easily be kept low by using pieces of a superconducting wire material that have different widths based on a difference in magnetic flux density.

According to the superconducting magnet of the first embodiment, the wire material portions having the smallest sectional area are placed closer to the inner side of the axial direction of the superconducting magnet than the wire material portions having the largest sectional area are. The magnetic flux density is lower on the inner side of the axial direction than on the outer side of the axial direction. The manufacturing cost of the superconducting magnet can consequently be kept low.

### Second Embodiment

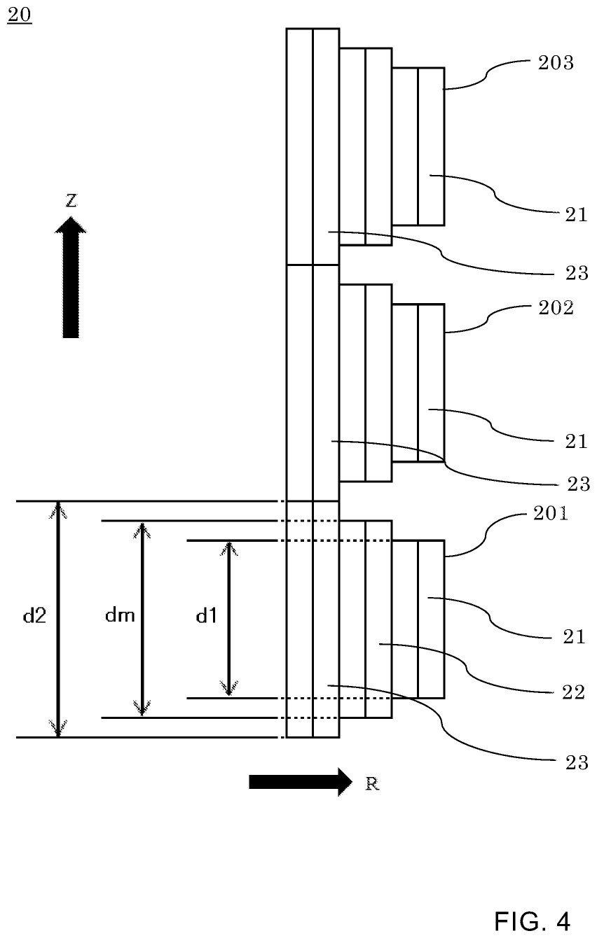

A superconducting magnet according to a second embodiment of the present invention is described next with reference to FIG. 4. In the configuration described in the first embodiment, the width of the superconducting wire material is varied in the axial direction Z. In the second embodiment, a configuration in which the width of the superconducting wire material is varied in the radial direction R is described.

FIG. 4 is a sectional view for illustrating a superconducting wire material of the superconducting magnet according to the second embodiment. The superconducting magnet according to the second embodiment includes a series of pieces of a superconducting wire material 20. The superconducting magnet includes three coils, namely, a coil 201, a coil 202, and a coil 203, which are pancake coils. The three coils 201 to 203 are stacked in the axial direction Z.

In each of the three coils 201 to 203, the superconducting wire material 20 is wound six turns into a spiral pattern. Each of the coils 201 to 203 includes a first wire material portion 21, an intermediate wire material portion 22, and a second wire material portion 23 from a radially outer side in the radial direction R of the superconducting magnet. In each of the coils 201 to 203, the first wire material portion 21, the intermediate wire material portion 22, and the second wire material portion 23 are each wound two turns. The first wire material portion 21 and the intermediate wire material portion 22 are connected in each coil. The intermediate wire material portion 22 and the second wire material portion 23 are connected in each coil. The first wire material portion 21, the intermediate wire material portion 22, and the second wire material portion 23 are connected in series.

A first width d1 of the first wire material portion 21 is less than a width dm of the intermediate wire material portion 22. The width dm of the intermediate wire material portion 22 is less than a second width d2 of the second wire material portion 23. The first width d1 of the first wire material portion 21 is accordingly less than the second width d2 of the second wire material portion 23. The thickness of the superconducting wire material 20 is constant irrespective of the positions of the coils. Thus, the thickness of the superconducting wire material 20 in the first wire material portions 21 is the same as the thickness of the superconducting wire material 20 in the second wire material portions 23. A first sectional area S1 of each of the first wire material portions 21 is accordingly smaller than a second sectional area S2 of each of the second wire material portions 23.

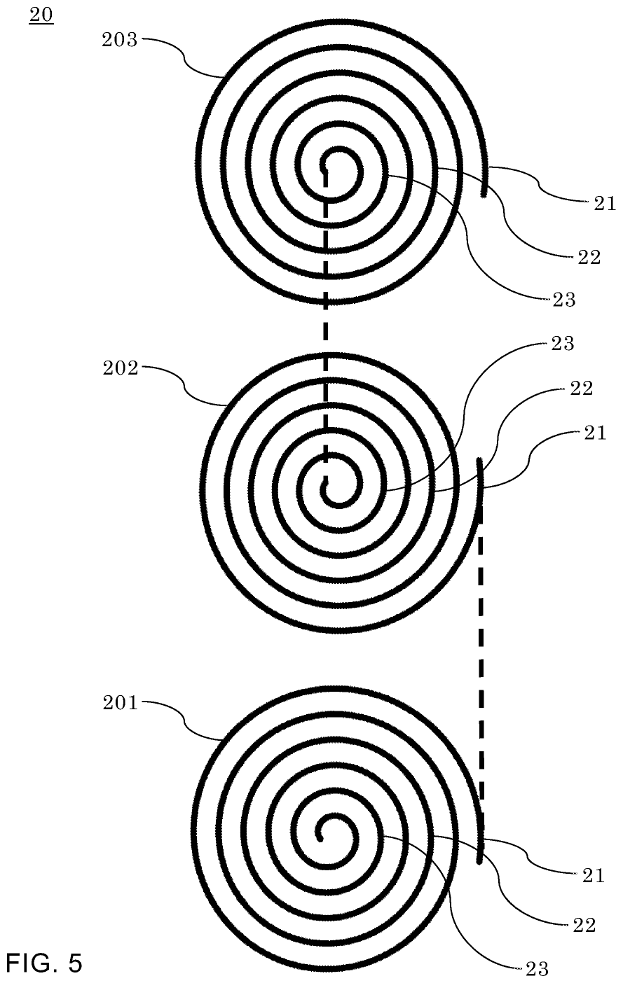

FIG. 5 is a schematic diagram for illustrating a state in which the coils are connected. In FIG. 5, the stacked coils 201 to 203 are illustrated as flatly arranged shapes. In order to set the direction of a magnetic force line of the superconducting magnet to one direction, the superconducting wire material 20 is connected so that a current flows in the same circumferential direction of the superconducting magnet in the coils 201 to 203. Short connection portions between the coils save the amount of wire material used. Adjacent coils out of the coils 201 to 203 are therefore connected to each other by connecting at the innermost or outermost circumferences of the adjacent coils.

For example, a case is considered in which one end of the superconducting wire material is placed in the second wire material portion 23 of the coil 201 and the superconducting wire material in the coil 201 is wound clockwise from the inner side of the radial direction R toward the outer side of the radial direction R. In this case, the first wire material portion 21 that is at the outermost circumference of the coil 201 is connected to the first wire material portion 21 that is at the outermost circumference of the coil 202 as indicated by the broken line of FIG. 5. The coil 202 is wound counterclockwise, starting from the second wire material portion 23, from the inner side of the radial direction R toward the outer side of the radial direction R. The second wire material portion 23 that is at the innermost circumference of the coil 202 is connected to the second wire material portion 23 that is at the innermost circumference of the coil 203 as indicated by the broken line of FIG. 5. The coil 203 is wound clockwise from the inner side of the radial direction R toward the outer side of the radial direction R.

In this case, when the turn direction of the coil 201 is a right-hand direction, the coil 202 has a turn direction that is a left-hand direction inverse to the turn direction of the coil 201. The turn direction of the coil 203 is a right-hand direction. The right-hand wind and the left-hand wind are therefore alternated among the connected coils. The wind of the coils and connection portions between the coils are not limited thereto. However, the wind of the coils is alternated among the coils in order to set the magnetic flux direction constant in the superconducting magnet.

With regards to connection among the first wire material portion 21, the intermediate wire material portion 22, and the second wire material portion 23, that is, the connection of pieces of superconducting wire material in one coil and the connection of pieces of superconducting wire material between coils, the front and rear are switched at each connection portion as described in the first embodiment.

The action of the superconducting magnet in the second embodiment is described next. When the superconducting wire material is wound in a spiral pattern in one coil, the magnetic flux density on the outer side of the radial direction of the coil is lower than the magnetic flux density on the inner side of the radial direction of the coil. The load factor of a piece of superconducting wire material that forms a coil on the outer side of the radial direction R of the superconducting magnet is accordingly lower than the load factor of a piece of superconducting wire material that forms a coil on the inner side of the radial direction R.

A current can flow in a superconducting wire material low in load factor with a superconductive state maintained, even when the sectional area of the superconducting wire material is small. In FIG. 4, a relationship among the first width d1 of the first wire material portion 21 on the outer side of the radial direction R of the superconducting magnet, the width dm of the intermediate wire material portion 22, and the second width d2 of the second wire material portion 23 on the inner side of the radial direction R is accordingly set as d1<dm<d2. This keeps the manufacturing cost of the superconducting magnet low.

Further, the first sectional area S1 of each of the first wire material portions 21 is the smallest of sectional areas of the superconducting wire material 20, and the second sectional area S2 of each of the second wire material portions 23 is the largest of the sectional areas of the superconducting wire material 20. The first wire material portions 21 having the smallest sectional area are therefore placed closer to the outer side of the radial direction of the superconducting magnet 1 than the second wire material portions 23 having the largest sectional area are. This keeps the manufacturing cost of the superconducting magnet low.

According to the superconducting magnet of the second embodiment, the sectional area of the superconducting wire material is set smaller in a portion relatively low in magnetic flux density, which varies depending on where the superconducting wire material is wound, than in a portion relatively high in magnetic flux density. More specifically, in the portion relatively low in magnetic flux density, the load factor is low, and a piece of superconducting wire material small in the sectional area taken along the plane perpendicular to the longitudinal direction of the superconducting wire material is accordingly used. Effective utilization of the superconducting wire material is consequently accomplished with a reduction of the wasteful use of the superconducting wire material, which helps to keep the manufacturing cost of the superconducting magnet low.

According to the superconducting magnet of the second embodiment, the wire material portions narrow in wire material width are placed on the outer side of the radial direction of the superconducting magnet. The magnetic flux density on the outer side of the radial direction is lower than the magnetic flux density on the inner side of the radial direction. The wire material width can consequently be varied depending on the magnetic flux density.

According to the superconducting magnet of the second embodiment, the wire material portions having the smallest sectional area are placed closer to the outer side of the radial direction of the superconducting magnet than the wire material portions having the largest sectional area are. The magnetic flux density is lower on the outer side of the radial direction than on the inner side of the radial direction. The manufacturing cost of the superconducting magnet can consequently be kept low.

### Third Embodiment

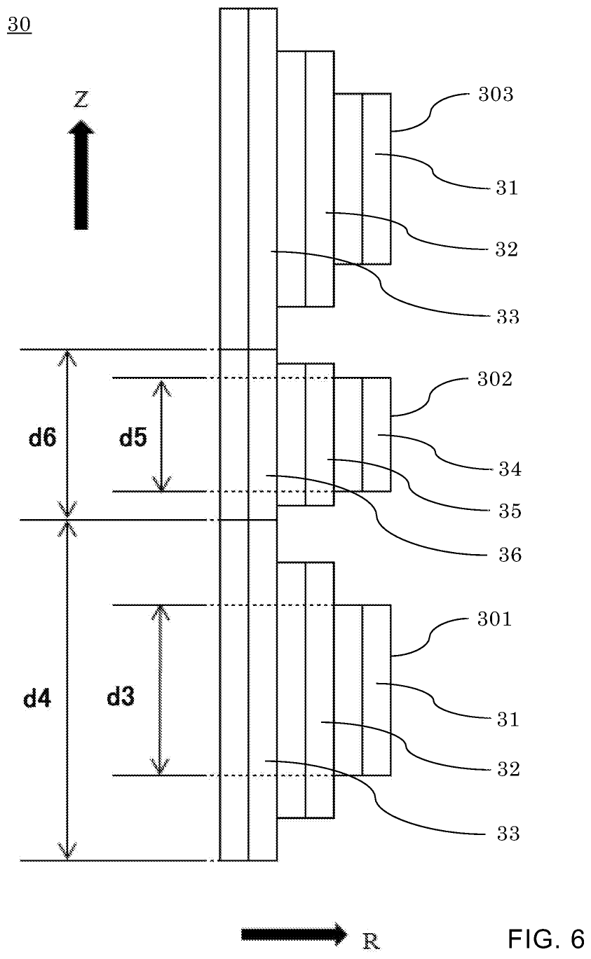

A superconducting magnet according to a third embodiment of the present invention is described next with reference to FIG. 6. In the case described in the first embodiment, the wire material portions narrow in the width of the superconducting wire material are placed close to the center in the axial direction of the superconducting magnet. In the case described in the second embodiment, the wire material portions narrow in the width of the superconducting wire material are placed on the outer side of the radial direction of the superconducting magnet. In the third embodiment, a case in which the placement configuration in the first embodiment and the placement configuration in the second embodiment are applied at the same time is described.

FIG. 6 is a sectional view for illustrating a superconducting wire material of the superconducting magnet according to the third embodiment. The superconducting magnet according to the third embodiment includes a series of pieces of a superconducting wire material 30. In the superconducting magnet according to the third embodiment, three stages of coils, namely, a coil 301, a coil 302, and a coil 303, are stacked along the axial direction Z of the superconducting magnet. The superconducting wire material 30 is wound into a spiral pattern in each of the coil 301, the coil 302, and the coil 303. The coil 303 has the same configuration as that of the coil 301. Although the configuration of the coil 303 is the same as the configuration of the coil 301 in this example, the coil 303 may have a configuration different from that of the coil 301.

Each of the coil 301 and the coil 303 includes an outer wire material portion 31, an intermediate wire material portion 32, and an inner wire material portion 33 from the outer side of the radial direction R of the superconducting magnet. In each of the coil 301 and the coil 303, the outer wire material portion 31, the intermediate wire material portion 32, and the inner wire material portion 33 are each wound two turns. A width d3 of the outer wire material portion 31 is less than a width dm1 of the intermediate wire material portion 32. The width dm1 of the intermediate wire material portion 32 is less than a width d4 of the inner wire material portion 33. The width d3 of the outer wire material portion 31 is therefore less than the width d4 of the inner wire material portion 33. A sectional area S3 of the outer wire material portion 31 is accordingly smaller than a sectional area S4 of the inner wire material portion 33.

The coil 302 includes an outer wire material portion 34, an intermediate wire material portion 35, and an inner wire material portion 36 from the outer side of the radial direction R of the superconducting magnet. In the coil 302, the outer wire material portion 34, the intermediate wire material portion 35, and the inner wire material portion 36 are each wound two turns. A width d5 of the outer wire material portion 34 is less than a width dm2 of the intermediate wire material portion 35. The width dm2 of the intermediate wire material portion 35 is less than a width d6 of the inner wire material portion 36. The width d5 of the outer wire material portion 34 is therefore less than the width d6 of the inner wire material portion 36. A sectional area S5 of the outer wire material portion 34 is accordingly smaller than a sectional area S6 of the inner wire material portion 36.

In the coil 301 and the coil 302, the coil 301 and the coil 302 can be viewed along the axial direction Z. For example, the width d5 of the outer wire material portion 34 of the coil 302 is less than the width d3 of the outer wire material portion 31 of the coil 301. The sectional area S5 of the outer wire material portion 34 of the coil 302 is accordingly smaller than the sectional area S3 of the outer wire material portion 31 of the coil 301.

Similarly, the width d6 of the inner wire material portion 36 of the coil 302 is less than the width d4 of the inner wire material portion 33 of the coil 301. The sectional area S6 of the inner wire material portion 36 of the coil 302 is accordingly smaller than the sectional area S4 of the inner wire material portion 33 of the coil 301.

In a through-view of the superconducting wire material 30 from the coil 301 to the coil 303, the sectional area S5 of the outer wire material portion 34 of the coil 302 is the smallest of the sectional areas of the superconducting wire material 30, and the sectional area S4 of the inner wire material portion 33 of the coil 301 is the largest of the sectional areas of the superconducting wire material 30. Accordingly, the outer wire material portion 34 of the coil 302 corresponds to the first wire material portion, and the sectional area S5 corresponds to the first sectional area. The inner wire material portion 33 of the coil 301 corresponds to the second wire material portion, and the sectional area S4 corresponds to the second sectional area. The outer wire material portion 34 of the coil 302 is closer to the inner side of the axial direction of the superconducting magnet than the inner wire material portion 33 of the coil 301 is, and is also placed closer to the outer side of the radial direction of the superconducting magnet than the inner wire material portion 33 of the coil 301 is. This keeps the manufacturing cost of the superconducting magnet low even more.

According to the superconducting magnet of the third embodiment, the sectional area of the superconducting wire material is set smaller in a portion relatively low in magnetic flux density, which varies depending on where the superconducting wire material is wound, than in a portion relatively high in magnetic flux density. More specifically, in the portion relatively low in magnetic flux density, the load factor is low, and a piece of superconducting wire material small in the sectional area taken along the plane perpendicular to the longitudinal direction of the superconducting wire material is accordingly used. Effective utilization of the superconducting wire material is consequently accomplished with a reduction of the wasteful use of the superconducting wire material, which helps to keep the manufacturing cost of the superconducting magnet low.

According to the superconducting magnet of the third embodiment, the wire material portion having the smallest sectional area is placed closer to the inner side of the axial direction of the superconducting magnet than the wire material portion having the largest sectional area is. The magnetic flux density is lower on the inner side of the axial direction than on the outer side of the axial direction. The manufacturing cost of the superconducting magnet can consequently be kept low.

According to the superconducting magnet of the third embodiment, the wire material portion having the smallest sectional area is placed closer to the outer side of the radial direction of the superconducting magnet than the wire material portion having the largest sectional area is. The magnetic flux density is lower on the outer side of the radial direction than on the inner side of the radial direction. The manufacturing cost of the superconducting magnet can consequently be kept low. The manufacturing cost of the superconducting magnet can be reduced further than in the first embodiment and the second embodiment because the wire material portion having the smallest sectional area is placed also closer to the inner side of the axial direction of the superconducting magnet than the wire material portion having the largest sectional area is.

Although the cases of using a high-temperature superconducting wire material are described in the first embodiment to the third embodiment, the same effects as those in the first embodiment to the third embodiment are obtained also when a low-temperature superconducting wire material is used. A high-temperature superconductor here means a superconductor having a phase transition temperature higher than 77 K which is the temperature of liquid nitrogen.

What is described in the first embodiment to the third embodiment is an example of embodiments, and the present invention is not limited thereto. For instance, the number of turns of the superconducting wire material in each coil is not limited to two turns or three turns. The pancake coils used in the described cases may be replaced by coils that are created by winding a superconducting wire material in the axial direction. The thickness of the superconducting wire materials 10, 20, and 30 is constant in the length direction of the superconducting wire material in the described cases, but may not be constant.

### REFERENCE SIGNS LIST

1 superconducting magnet,

10, 20, 30 superconducting wire material,

11, 21 first wire material portion,

12, 23 second wire material portion,

33 inner wire material portion (second wire material portion),

34 outer wire material portion (first wire material portion),

d1 first width,

d2 second width,

R arrow (radial direction),

S1, S5 first sectional area,

S2, S4 second sectional area,

Z arrow (axial direction)

1-6. (canceled)

7. A superconducting magnet, comprising a wound high-temperature superconducting wire material,
wherein the high-temperature superconducting wire material comprises a configuration part in which, based on a difference in a magnitude of a radial direction component of a magnetic flux density in a radial direction of the superconducting magnet, which varies depending on a position at which the high-temperature superconducting wire material is wound, a sectional area of a part having the relatively small in the radial direction component of the magnetic flux density in the superconducting magnet is formed to be smaller than a sectional area of a part having the relatively large in the radial direction component of the magnetic flux density in the superconducting magnet.

8. The superconducting magnet according to claim 7,
wherein the high-temperature superconducting wire material comprises two or more wire material portions including a first wire material portion and a second wire material portion, the first wire material portion being wound at the part having the relatively small in the radial direction component of the magnetic flux density, the second wire material portion being wound at the part having the relatively large in the radial direction component of the magnetic flux density, and
wherein the first wire material portion has a first sectional area taken along a plane perpendicular to a longitudinal direction of the high-temperature superconducting wire material, the second wire material portion has a second sectional area taken along the plane perpendicular to the longitudinal direction of the high-temperature superconducting wire material, and the first sectional area is smaller than the second sectional area.

9. The superconducting magnet according to claim 8,
wherein the high-temperature superconducting wire material has a rectangular shape having a width and a thickness in a cross section perpendicular to the longitudinal direction thereof, and
wherein the high-temperature superconducting wire material has a first width in the first wire material portion and a second width in the second wire material portion, the first width being less than the second width.

10. The superconducting magnet according to claim 8,
wherein the first sectional area is the smallest of sectional areas of the high-temperature superconducting wire material,
wherein the second sectional area is the largest of the sectional areas of the high-temperature superconducting wire material, and
wherein the first wire material portion is provided closer to an inner side of an axial direction of the superconducting magnet than the second wire material portion.

11. The superconducting magnet according to claim 9,
wherein the first sectional area is the smallest of sectional areas of the high-temperature superconducting wire material,
wherein the second sectional area is the largest of the sectional areas of the high-temperature superconducting wire material, and
wherein the first wire material portion is provided closer to an inner side of an axial direction of the superconducting magnet than the second wire material portion.

12. The superconducting magnet according to claim 8,
wherein the first sectional area is the smallest of sectional areas of the high-temperature superconducting wire material,
wherein the second sectional area is the largest of the sectional areas of the high-temperature superconducting wire material, and
wherein the first wire material portion is placed closer to an outer side of a radial direction of the superconducting magnet than the second wire material portion.

13. The superconducting magnet according to claim 9,
wherein the first sectional area is the smallest of sectional areas of the high-temperature superconducting wire material,
wherein the second sectional area is the largest of the sectional areas of the high-temperature superconducting wire material, and
wherein the first wire material portion is placed closer to an outer side of a radial direction of the superconducting magnet than the second wire material portion.

14. The superconducting magnet according to claim 10,
wherein the first sectional area is the smallest of sectional areas of the high-temperature superconducting wire material,
wherein the second sectional area is the largest of the sectional areas of the high-temperature superconducting wire material, and
wherein the first wire material portion is placed closer to an outer side of a radial direction of the superconducting magnet than the second wire material portion.

15. The superconducting magnet according to claim 11,
wherein the first sectional area is the smallest of sectional areas of the high-temperature superconducting wire material,
wherein the second sectional area is the largest of the sectional areas of the high-temperature superconducting wire material, and
wherein the first wire material portion is placed closer to an outer side of a radial direction of the superconducting magnet than the second wire material portion.

16. A method of manufacturing a superconducting magnet, the superconducting magnet including a first coil and a second coil, which are wound pieces of a superconducting wire material,
the method comprising winding the superconducting wire material in the second coil from an inner side of the superconducting magnet toward an outer side of the superconducting magnet, in the direction opposite to a direction in which the superconducting wire material in the first coil is wound from the inner side of the superconducting magnet toward the outer side of the superconducting magnet.

17. A method of manufacturing a superconducting magnet, comprising switching a front and a rear of a superconducting wire material included in the superconducting magnet each time pieces of the superconducting wire material are connected.
